(19) United States
(12) Patent Application Publication
(10) Pub. No.: US 2002/0049770 A1
(43) Pub. Date: Apr. 25, 2002

(54) System and method for distributed audience profile development through consensual interaction with a network

(76) Inventor: Vijay Mayadas, Boston, MA (US)

Correspondence Address: PERKINS, SMITH & COHEN LLP, ONE BEACON STREET, 30TH FLOOR, BOSTON, MA, 02108, US

(21) Appl. No.: 09/796,935

(22) Filed: Feb. 28, 2001

Related U.S. Application Data
(60) Provisional application No. 60/185,626, filed on Feb. 29, 2000.

(51) Int. Cl. G06F 7/00

(52) U.S. Cl. 707/104.1

(57) ABSTRACT

User profile data are aggregated through a plurality of data aggregators, which in the present embodiment of the invention are web sites. When a consumer interacts with an aggregator, the aggregator asks questions that the user has an option to answer. Answers given by the user are submitted to a centralized profile repository where the answers become part of the user's individual profile. The answers are tagged with a unique identifier for the aggregator. The aggregator may be remitted payment for the consumer data it aggregates and submits to the central repository. When the user visits a publisher, the use may view and interact with targeted messages such as ads. The interaction with the advertisements results in payment to the consumer and the publisher of the ad.

### CROSS-REFERENCE TO RELATED APPLICATIONS

This application claims priority of U.S. provisional applications Serial No. 60/185,626 entitled, “System and Method for Distributed Audience Member Profile Development Through Consensual Interaction with a Network” filed Feb. 29, 2000 by the present applicant.

### FIELD OF THE INVENTION

This invention relates generally to collecting and maintaining consumer data and more particularly to Web user profile aggregation.

### BACKGROUND OF THE INVENTION

It is generally believed in the advertising industry that advertisement is more effective if targeted in subject matter and frequency to a receptive audience. In order to so target a particular user, an advertiser must know something about that user. Vendors and other entities have long been using surveys to accomplish the task of gathering data about users both in groups and as individuals. With the development of the World Wide Web (the Web), entities have been following Web users' movements and selections on the Web in order to gather useful data to further their purposes. Some present systems use passive profile information gathered by passively observing a user's habits without the user's knowledge. This approach is limited to gathering data only on what the user does or selects among limited options, not what the user wants or thinks beyond the webpage presented.

Computer surveys combine the survey function with the speed and data capture capability of computers. Present systems, however, limit themselves to a static set of questions collected at one central location. It is desired to have a richer input from consenting audiences.

It remains desirable to have a system for aggregating data to develop multidimensional user profiles.

It is an object of the present invention to provide a method and apparatus to gather user data for profiles from a plurality of sources.

It is another object of the present invention to provide a method and apparatus for gathering user data across a diverse set of queries to provide more substantial profiles.

### SUMMARY OF THE INVENTION

The problems of user profile development are solved by the present invention of a system and method for distributed aggregation of user preferences through consensual interaction with network elements.

Profile data are aggregated through a plurality of data aggregators, which in the present embodiment of the invention are web sites. When a user interacts with an aggregator, the aggregator asks questions that the user has an option to answer. Answers given by the user are submitted to a centralized profile repository where the answers become part of the user's individual profile. The answers are tagged with a unique identifier for the aggregator. The aggregator may be remitted payment for the consumer data it aggregates and submits to the central repository. When the user visits a publisher, the user may view and interact with targeted messages such as advertisements. The participating user's interaction with the advertisements results in payment to the consumer. Delivery of the targeted message results in payment to the aggregator.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of a profile data gathering system according to principles of the invention;

FIG. 2 is partly a flow chart of the of the method of developing a profile according to principles of the invention and partly a block diagram of the system of FIG. 1; and

FIG. 3 is a screen shot of an exemplary question shown by a submitter in the profile gathering system of FIG. 1.

### DETAILED DESCRIPTION OF PREFERRED EMBODIMENTS

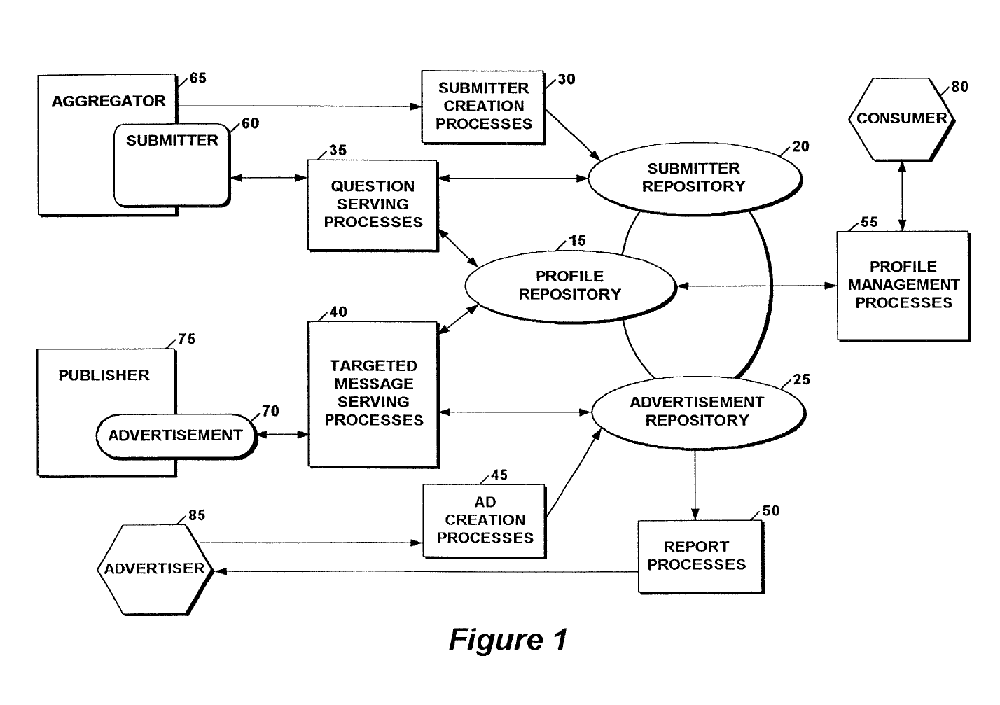

FIG. 1 shows the profile data gathering system of the present invention. The profile data gathering system has a profile data repository 15, a submitter repository 20, and an advertisement repository 25. These repositories 15, 20, 25 are collectively called the central repositories. The profile gathering system also has submitter creation processes 30, question serving processes 35, targeted message serving processes 40, ad creation processes 45, report processes 50, and profile management processes 55. The profile gathering system serves two clients, submitter 60 served to an aggregator 65 and an advertisement client 70 served to a publisher 75.

The aggregator 65 is an entity that collects profile data from consumers. An example of an aggregator 65 is a web site, however, the aggregator may be any interface, such as an interactive kiosk, capable of prompting for data and receiving responses from a user. A publisher 75 is an entity that displays targeted messages from advertisers targeted to particular consumers. An example of a publisher is a web site. The publisher, however, may be any medium capable of identifying its user and displaying targeted messages. In operation, publisher web sites will generally be the same as aggregator web sites. The aggregator and publisher may be the same entity capable of gathering user data and providing targeted messages.

The profile repository 15 stores profiles, also called consumer profiles or user profiles. A profile contains detailed information about the user. The profile includes any data gathered by the system about the user. The profile is not limited to a single data entry form or traditional demographic data. Each fact about the user is referred to as a profile point. Examples of profile points are “owns a Ford” and “likes puppies.” The user may view and edit his or her profile and thus participate directly in profile development instead of interacting with aggregators and relying only on answering questions asked by the system.

The profile repository 15 is managed by profile management processes 55. Users including consumers register with the profile data gathering system. The profile management processes 55 handle user registration and profile creation. Personal data provided during the registration process is stored away from the central repositories and offline from the Internet. Personal data includes user name, address, telephone number and payment information. An anonymous identifier is used to represent the user in the central repositories. Other information associated with a user in the central repositories is 5-digit zip code and a telephone area code.

The submitter repository 20 stores questions to be asked of a user in order to obtain data for the user's profile. The form of the question typically will be a question with a plurality of answers from which the user chooses an answer to submit in response. Submitter creation processes 30 receive and store questions from the aggregator 65. Submitter creation processes are also used to create submitters to be put on aggregator web sites. Question serving processes 35 select questions from the submitter repository 20 in response to a user interfacing with the aggregator 65. The question serving processes 35 selects the questions to be served to the submitter 60 based on aggregator requirements and on the user's profile. Questions that the user has already been asked generally will not be asked again.

The advertisement repository 25 stores the targeted messages to display to the user. Ad creation processes 45 take advertisement submissions from advertisers 85, and handle ad creation and associated targeting data. Each advertisement has associated targeting data indicating what profile points should be present in a user's profile in order for the user to view the advertisement. The advertisement serving processes 40 determine what advertisements to show to a user interacting with the publisher page. The advertisement serving processes 40 select ads to be shown based on the requirements associated with the ad and the profile of the user. Report processes report 50 back to the advertiser how many users viewed the ad and the profile characteristics of those users. The report processes include data on profile differentiation between users who clicked on an ad and user who interacted with an ad. A report may, for example, include information such as women clicked on a particular ad 30% more than men.

In operation, a user registers with the profile data gathering system. The user provides basic information including a method of receiving payment from the system for participating. After registration, whenever a user interacts with an aggregator 65, the user has an option to interact with the submitter 60 and to view and answer questions. A submitter's HTML tags on an aggregator web site activate Java servlets from the system that form the question serving processes. The servlets communicate with the central repositories to get questions. The answers to the questions are submitted to the system where the profile management processes 55 add the answers to the user's profile. Also, whenever the user interacts with a publisher 75, the advertisement client 70 receives at least one advertisement through the ad serving processes 40. The advertisement client 70 displays the advertisement to the user. The user may choose to interact with the advertisement, that is, the user may choose to click through the advertisement or may merely indicate that the ad was seen. The interaction is dependent on the requirements of the advertisement.

The user's interaction with the system results in payment to the user. Both the interaction with the aggregator in providing profile data and the interaction with the advertisements can result in payment to the user depending on predefined conditions in the system. For example, the user may receive payment for clicking on an ad indicating that the ad was seen. This is recorded and reported to the advertiser.

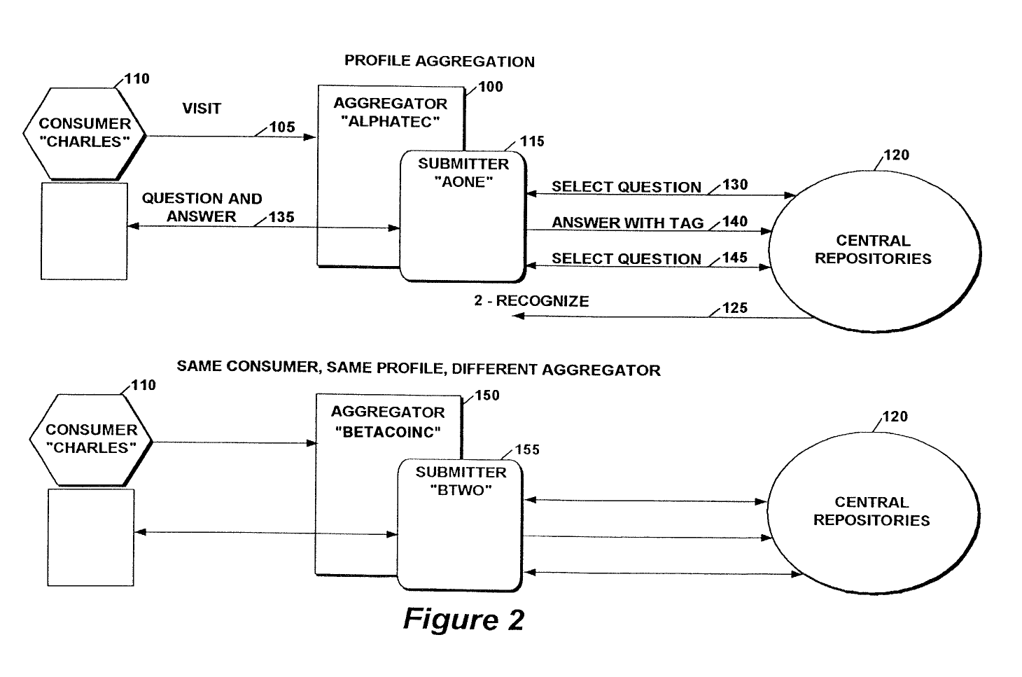

FIG. 2 shows the process of developing a profile according to principles of the invention. A first data aggregator 100 is visited 105 by a consumer, step 110. A first submitter 115 checks cookies on the consumer's access system to see if the consumer is registered with the system. Alternatively, the first submitter 115 contacts the system and accesses the central repositories 120 to determine whether the user is registered. This is sometimes referred to as “recognizing” the consumer, step 125. The first submitter has a first subset of questions. If the user is a registered with the system, the first submitter 115 chooses an appropriate question from the first subset of questions, step 130.

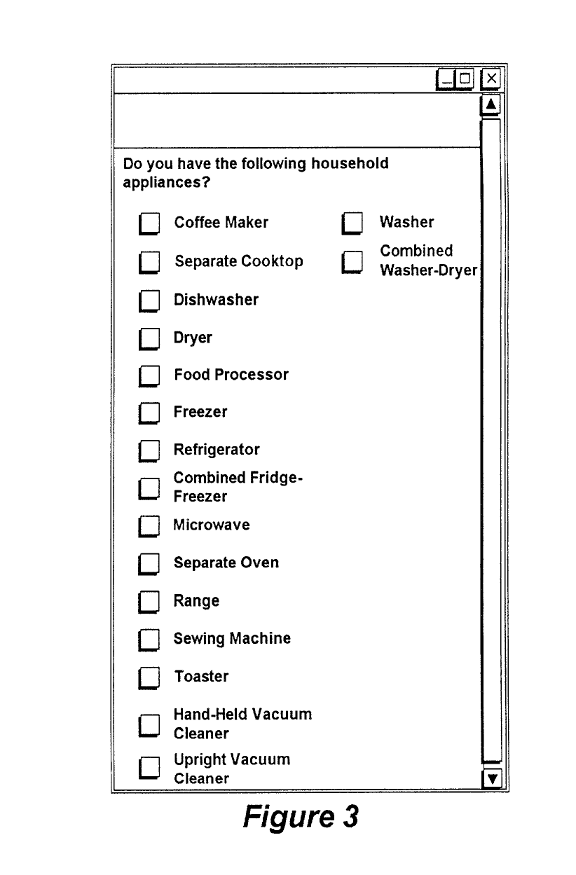

FIG. 3 shows an exemplary question asked by a submitter. The question is presented in an interactive way on the user's screen. The question shown in FIG. 3 has a plurality of check boxes and the user may check one or more of the boxes. The answers are then submitted to the profile repository. Each submitter is customized to ask only a subset of the questions stored in the submitter repository. The subset of questions generally contains questions of interest to the aggregator. The question submitter chooses the most appropriate question out of its set to ask the consumer. Questions which the user has already answered are excluded. The submitter determines whether a question has already been asked from the user's profile stored in the profile repository. Questions which are invalid for this particular user can be recognized and excluded based on the user's profile data.

Returning to FIG. 2, the first submitter displays the question to the consumer and receives the consumer's response, step 135. The consumer's answer is transmitted to the central repositories 120 to become a profile point of that consumer's profile, step 140. The profile point is tagged with a unique identifier for the aggregator. The purpose of that tag is so that the aggregator may later be paid for that information.

The question submitter then determines an appropriate next question to display to the consumer and then displays that question, step 145.

The consumer's profile is developed further when the user visits other aggregators. For example, the consumer 110 next visits a second aggregator 150 with a second submitter 155. The second submitter 155 has a second subset of questions, questions of interest to the second aggregator 150. The subset of the first aggregator may overlap with the subset of the second aggregator but submitters have access to all the information in the central repositories 120, so if the consumer has answered a question at the first aggregator the consumer need not be asked it again at the second aggregator. An aggregator may have a plurality of submitters.

If an unregistered user visits an aggregator, the user is still given the option of answering questions. If the user visits a data aggregator without having answered a question before, the consumer has no profile and is not tracked by the central system until a question is answered. The submitter determines a default question to ask the user, a question which requires the submitter to know nothing about the user already.

Once the unregistered user answers a question, the unregistered user is tracked by the system in the same way that a registered user would be. The only difference is that the system does not yet have a registration form for the user. The central system will recognize the unregistered user when the unregistered user visits other aggregators and will continue to gather information through the submitters.

The questions asked by the submitters are potentially unlimited. While at any given time the submitters can only include questions about types of data that are in the profile system, the profile is constructed to grow and gain depth through use. The profile data aggregation differs from a system in which a static set of demographic data might be collected in this aspect and also in the distributed nature of the data aggregation.

The central data repositories are relational databases each storing an object hierarchy tree. For example, the profile repository is a object hierarchy tree of user profile points that is flattened and stored in a relational database. This allows for fast searching using the relational database while allowing for flexible data structure without major database administration.

Profile points in the profile database are instances of objects. Each object also has a class, which determines what attributes it has. Classes are also structured in trees. Questions answered add new leaves to the tree which in turn become parent nodes as subsequent questions are answered. Each node in the tree remains accessible individually so that users may be targeted on general or specific aspects of their profiles.

An example object is “Ford Focus.” Its parent is “Ford Cars” whose parent is “Cars” whose parent is “Vehicles.” The Focus is of class “Car Make and Model” whose parent is “Car Make” whose parent is “Vehicle Car” whose parent is “Vehicle”. The definition of “Car Make and Model” determines what attributes the “Ford Focus” is allowed to have: perhaps original manufacturer (which could well be Mitsubishi in the case of Ford cars), body style, etc.

Each node of the tree is flattened into multiple rows in various database tables. This allows the use of relational database searches to find things such as “all car models actually made by Mitsubishi.”

The user profile takes these objects and creates an individual instance of them transforming “Ford Focus” into “My main automobile is a Ford Focus.” Additional descriptive properties can be added to the particular instance, for instance having four or two doors, or being green. By answering questions, the user builds up these instances in the profile.

The present embodiment of the invention uses an Oracle relational database with PLSQL procedures in order to manage the profile points, but any relational database and relational database language of sufficient power could be used.

The preferred embodiment of the invention operates on computers connected to the Internet, however alternative embodiments of the invention could appear on cell phones and PDAs, or digital TV.

An alternative embodiment to the present invention is a system without submitters where the aggregators have direct access to the profile repository. In this embodiment of the invention, the aggregators may submit profile points without using questions to gather them. This alternative embodiment would also have additional steps of establishing trust between the profile gathering system and the aggregator.

Alternative embodiments of the invention would include question creation for the aggregators. The aggregator would create a list of questions and data to be submitted to the central repository rather than choose from the list of possible questions stored in the submitter repository.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A process for dynamically developing an electronic database of profile points for potential human recipients of targeted electronic messages, said process comprising the steps of:
a) in a first session, querying, by a participating profile point aggregator, for at least one profile point for a potential recipient of targeted electronic messages;
b) if information is received in positive response to such querying, electronically associating in said electronic database of profile points an identifier of said potential recipient with said response;
c) in a subsequent session, querying, by a participating profile point aggregator, for at least one profile point for said potential recipient; and
d) if information is received in positive response to such subsequent querying, electronically associating in said electronic database said identifier of said potential recipient with said response to said subsequent querying;
wherein said profile point is an instance of an object organized in at least one class that determines what queries are made.

2. The process of claim 1 wherein at least one of said steps of querying is made to said potential recipient when said potential recipient electronically accesses said participating profile point aggregator.

3. The process of claim 1 wherein the participating profile point aggregator in said first session is a different entity from the participating profile point aggregator in said subsequent session.

4. The process of claim 1 wherein at least one profile point for said potential recipient queried in said subsequent session is distinct from any profile point for said potential recipient queried in said first session.

5. The process of claim 1 further comprising the electronic delivery of targeted electronic messages to said potential recipient according to said class and any existing profile points for said potential recipient.

6. The process of claim 2 further comprising the electronic payment of fee automatically upon receipt of a positive response to querying in each session in which querying is made directly to said potential recipient.

7. A system for dynamically developing an electronic database of profile points for potential human recipients of targeted electronic messages, said system comprising:
a) an electronic database wherein profile points are instances of objects organized in at least one class that determines queries for acquisition of said data points for potential recipients of targeted messages;
b) at least one participating profile point aggregator is adapted to make queries according to said class and any existing profile points for a potential recipient of targeted electronic messages and to provide for update to said database any profile points received in response to said queries.

8. The system of claim 7 wherein at least one participating profile point aggregator is adapted to make said queries to said potential recipient when said potential recipient accesses electronically said participating profile point aggregator.
